(19) United States
(12) Patent Application Publication
(10) Pub. No.: US 2014/0265283 A1
(43) Pub. Date: Sep. 18, 2014

(54) Service Vehicle Operation Training System and Method

(71) Applicant: Jeff Tad Clifton, Aledo, TX (US)

(72) Inventor: Jeff Tad Clifton, Aledo, TX (US)

(21) Appl. No.: 14/210,645

(22) Filed: Mar. 14, 2014

Related U.S. Application Data
(60) Provisional application No. 61/792,768, filed on Mar. 15, 2013.

(51) Int. Cl. B60R 21/13

(52) U.S. Cl. CPC B60R 21/13
USPC 280/755

(57) ABSTRACT

The system is adapted to be installed on a vehicle and comprises a skid simulation system and a lateral stability system. The skid simulation system generally comprises deployable auxiliary wheel assemblies which, when lowered, reduce or eliminate the weight placed upon the conventional wheels and tires. The auxiliary wheel assemblies are positioned near the conventional wheels and comprise a wheel that is free spinning about a horizontal axis and a vertical axis. The lateral stability system generally comprises a plurality of deployable lateral support members which may be manually deployed from housing compartments or automatically deployed upon receipt of a signal from sensors such as accelerometer sensors that the vehicle is in danger of overturning.

### FIELD OF THE INVENTION

The present invention relates generally to a vehicle operation training system and specifically to a vehicle operation training system for use with service vehicles such as fire trucks and ambulances as well as other high profile vehicles such as buses.

### BACKGROUND OF THE INVENTION

Fire trucks, ambulances, and other service vehicles are very heavy, weighing tens of thousands of pounds. When fully loaded with equipment, water, and personnel, a fire truck, for example, can weigh as much as 60,000 pounds. By way of further example, a fully loaded ambulance, can weigh almost 20,000 pounds. Moreover, fire trucks, ambulances, and other service vehicles may be “top heavy” in that they may have high centers of gravity. The further away from the ground that the vehicle's center of gravity is, the less stable the vehicle becomes. Vehicles that are top heavy are more susceptible to the effects of sudden turns and movements than vehicles with lower centers of gravity.

Being emergency vehicles, fire trucks and ambulances are often operated in emergency conditions which are less than ideal. For example, it is not uncommon for these vehicles to be operated in rainy and icy conditions, on poor and dimly lit roads, and at high speeds. Even in the absence of these conditions, accidents may occur. One of the most common accidents involving emergency vehicles is a “rollover” in which the vehicle overturns. Rollovers are generally categorized as either “tripped” or “untripped”. A tripped rollover results from one side of the vehicle being lifted after striking an object such as a curb, rock, or guardrail or from tires digging into soft soil or mud. An untripped rollover results from high lateral acceleration during turning.

However, adverse roadway conditions often play a role in emergency vehicle accidents. Even with their great weight, emergency vehicles are susceptible to losing traction as a result of rain, ice, snow, loose roadway material (such as may be found on an unpaved road), and other slippery conditions. Such accidents are generally caused by a combination of factors, including, the unfavorable road conditions, excessive speed, steering (under-correction or over-correction), and braking. Because of the enormous weight of a fire truck, for example, the stopping distance on a precipitation covered road may be up to 15 times the stopping distance for the same vehicle under dry conditions.

Emergency vehicle accidents can cause severe damage to the emergency vehicle itself as well as other vehicles. As a result, the emergency vehicle may be unable to respond to the emergency at hand as well as future emergencies. In more serious cases, injury or even death may occur. Consequently, as fire trucks and ambulances are operated under very trying conditions, it is exceedingly important that the operators of these vehicles be well trained and experienced such that they are able to understand the causes of rollovers and loss of vehicle traction. With such training and experience, a vehicle operator will be more likely to identify and avoid conditions that may lead to loss of vehicle traction and/or a rollover. Moreover, the trained and experienced vehicle operator will know how to respond in the event the vehicle does begin to lose traction or roll over.

The present disclosure provides a vehicle operation training system comprising a conventional vehicle such as a fire truck or ambulance adapted to simulate slippery or icy conditions. The vehicle comprises deployable auxiliary wheel and tire assemblies which, when lowered, reduce or eliminate the weight placed upon the conventional wheels and tires. The auxiliary wheel and tire assemblies are positioned near the conventional wheels and comprise a wheel and tire that is free spinning about a horizontal axle and a vertical axle.

Additionally, the training system comprises a plurality of deployable lateral support assemblies which may be manually deployed from housing compartments or automatically deployed upon receiving a signal from accelerometer sensors that the vehicle is in danger of overturning. These lateral support assemblies comprise wheels or, alternatively, pads at the ends which contact the driving surface and stabilize the vehicle such that it will not overturn.

With the system of the present invention, multiple combinations of vehicle operation training scenarios are possible. Many variables and conditions may be presented when operating an emergency vehicle. With this system, the vehicle operator learns what these variables are, how to account for and compensate for them, and, thus, safely operate the vehicle in a variety of conditions and a number of scenarios.

### DESCRIPTION OF THE PRIOR ART

There have been several attempts to provide training simulators for use with passenger vehicles. For example, Vecchi, U.S. Pat. No. 1,661,641, discloses a device which may be used when a tire is punctured or a wheel is broken. A caster wheel for each wheel of the automobile is provided which may be lowered, thereby raising the corresponding corner of the automobile when the tire is punctured so that the caster wheel supports that corner of the automobile and it is not necessary, to run on the flat tire and damage the casing. Johansson et al, U.S. Pat. No. 4,700,798, discloses a driver training apparatus for simulating skid conditions of an automobile. The Johansson apparatus comprises a separate lifting frame carried by four caster wheels. Under ordinary driving conditions, the caster wheels turn to follow the movements of the car directed by the driver. Under control of an instructor, the frame can raise one or more of the car wheels relative to the ground, to simulate a predetermined skid condition. Orloski, Jr., U.S. Pat. No. 4,998,594, discloses a driver training apparatus for simulating skid conditions of a vehicle. The apparatus of Orloski includes a lifting frame supported by four caster wheels. The frame underlies and is connected with the vehicle suspension system and is propelled by the vehicle. Under normal driving conditions, the caster wheels turn in the direction of movement of the vehicle steered by the driver. Under the control of an instructor, the frame of the apparatus can raise the forward or rearward pairs of the caster wheels simultaneously or individually to raise the forward and rearward pairs of wheels relative to the surface of a roadway to simulate a slick road or skidding condition. Under the control of the instructor, the pivoting axis of the caster wheels can be inclined with respect to vertical to stabilize lateral or forward movement of the vehicle when partially supported by the driver training apparatus. Mottola et al., U.S. Pat. Nos. 5,626,362, 5,743,562, and, 6,024,381 disclose an apparatus with a tire that is capable of castering 360 degrees and replaces the rear wheels of a front wheel powered automotive vehicle to give drivers an educational experience that simulates the effects excessive speed has upon entry into curves and turns. Poulin et al., U.S. Pat. No. 6,234,527, discloses a lifting device for lifting the trailing end of a road vehicle and used to laterally move the vehicle. Dziak, US. Patent Publication 20060070783 discloses a system of imitating automotive vehicle skidding on a straight or curved part of a track utilizing a front wheel drive vehicle.

There are several references teaching lateral stabilizers. For example, Denney et al., U.S. Pat. No. 3,397,898, discloses a stabilizing device to prevent the overturning of a farm tractor working on a steep incline. Watkins, U.S. Pat. No. 5,257,671 and U.S. Pat. No. 5,628,379 disclose a vehicle having retractable outrigger/side wheels on opposite sides of the frame. Hrovat et al., U.S. Pat. No. 8,108,104 discloses a rollover stability control system for a vehicle may include a lateral support system. Lu et al., U.S. Pat. No. 7,194,351, teaches system and method for determining a wheel departure angle for a rollover control system.

Although, there are a number of patents and patent publications teaching training vehicles comprising caster assemblies which may be used to simulate a skidding vehicle and there are a few references disclosing rudimentary lateral stabilizers. None of the above reference discloses a reliable and completely integrated and automated system for use in the training of emergency vehicle operators in the operation and use of emergency vehicles. What is needed is a reliable and completely integrated and automated system an emergency vehicle training system comprising a state of the art skid simulation system in combination with an automated lateral support system.

### SUMMARY OF THE INVENTION

The present disclosure provides a vehicle operation training system comprising a conventional emergency vehicle such as a fire truck or ambulance adapted to simulate slippery or icy conditions. The vehicle comprises deployable auxiliary wheel and tire assemblies which, when lowered, reduce or eliminate the weight placed upon the conventional wheels and tires. The auxiliary wheel assemblies are positioned near the conventional wheels. The auxiliary wheel assemblies comprise a wheel and swivel arrangement. The wheel is free spinning about a horizontal axis and the swivel is free spinning about a vertical axis. When deployed, the auxiliary wheel assemblies cause the vehicle to skid, the amount of skid being dependent upon, in part, the amount of weight removed from the conventional wheels and tires. Thus, a training opportunity is presented to students regarding the correct technique in managing skidding situations.

Additionally, the training system comprises a plurality of deployable lateral support assemblies which may be manually deployed from housing compartments or automatically deployed upon receipt of a signal from accelerometer sensors that the vehicle is in danger of overturning. These lateral support assemblies comprise pads or, alternatively, wheels at the ends which contact the driving surface and stabilize the vehicle such that it will not overturn.

Although, the system and method are currently well adapted for use with fire trucks and ambulances, the system is also well suited for use with other service vehicles such as city buses, school buses, taxis, police cars, passenger vans, as well as non-service vehicles. The system is adapted for use with virtually any service vehicle in use today, whether the apparatus is manual or electronically controlled.

The system further comprises pic technology with a state of the art touch screen computer controller. In the preferred embodiment, the system comprises a touch screen HMI (Human Machine Interface) connected to a PLC (programmable logic controller) which controls a hydraulic and air system of the vehicle as well as an overturn prevention system (which may comprise pneumatically deployed/retracted lateral support members), retrieves data from sensors, and displays results of the student's performance on the HMI. The basic operation begins when the instructor sets up the simulator by selecting a desired road condition or other anomaly to be presented to the student. The instructor may also choose from one of several preprogrammed scenarios from the computer. With the two computer systems, if the student makes an incorrect move threatening the safety of the vehicle and its occupants, the instructor or computer can take over the scenario by deploying the overturn prevention system. The instructor can do this by simply pressing a button and/or the computer can do this by, for example, sensing an excessive lateral G load or that the truck has tipped beyond a predetermined level.

With the system of the present invention, multiple combinations of vehicle operation training scenarios are possible. Many variables and conditions may be presented when operating an emergency vehicle. With this system, the vehicle operator learns what these variables are, how to account for and compensate for them, and, thus, safely operate the vehicle in a variety of conditions and a number of scenarios.

### BRIEF DESCRIPTION OF THE DRAWINGS

FIG. 1 is a conceptual side elevation view of the system of the present invention in accordance with a preferred embodiment.

FIG. 2 is a conceptual side elevation view of the system of the present invention with the lateral support members in a retracted position, in accordance with a preferred embodiment.

FIG. 3 is a conceptual view of the under carriage of the skid simulation system, in accordance with a preferred embodiment.

FIG. 4 is a close-up view of the circled area of FIG. 3.

FIG. 5 is a conceptual front elevation, partially exploded, view of the overturn prevention system of the present invention, in accordance with a preferred embodiment.

FIG. 6 is a left, front, and top isometric view of the lower portion of the skid simulation system, in accordance with a preferred embodiment.

FIG. 7 is a top and rear isometric view of the skid simulation system undercarriage frame assembly, in accordance with a preferred embodiment.

FIG. 8 is a top and rear isometric view of a portion of the lateral support assembly, in accordance with a preferred embodiment.

FIG. 9 is an isometric view of the lower portion of the lateral support assembly disconnected from the mid-portion.

FIG. 10 is an isometric view of an alternative deployment mechanism for use with the lateral support assembly.

### DESCRIPTION OF THE PREFERRED EMBODIMENT

A preferred embodiment of the system 12 is presented in the figures referenced above. In describing the embodiments of the invention, specific terminology will be used for the sake of clarity. However, the invention is not intended to be limited to the specific terms so selected, it being understood that each specific term includes all technical equivalents operating in a similar manner to accomplish a similar purpose. It is understood that the drawings are not drawn exactly to scale. In the drawings, similar reference numbers are used for designating similar elements throughout the several drawings.

This specification describes particular embodiments of the invention. However, it should be understood, based on this disclosure, that the invention is not limited to the embodiments detailed herein. As used herein, the terms “a” or “an” shall mean one or more than one unless otherwise indicated herein or clearly contradicted by context. The term “plurality” shall mean two or more than two. The term “another” is defined as a second or more. The terms “including” and/or “having” are open ended (i.e., meaning “including, but not limited to,”) unless otherwise noted. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive. Recitation of ranges of values herein is merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation. The detailed description illustrates by way of example, not by way of limitation, the principles of the invention. This description will clearly enable one skilled in the art to make and use the invention, and describes several embodiments, aspects, adaptations, variations, alternatives, and uses of the invention, including what is presently believed to be the best mode of carrying out the invention.

The examples and illustrations of a vehicle training system are described herein with respect to a vehicle training system for use with emergency vehicles such as fire trucks and ambulances. However, the system is equally applicable for use with other vehicles. Moreover, while certain materials are discussed herein with respect to various components of the various embodiments, the embodiments are not limited to such materials. For example, in a preferred embodiment, certain components are formed from steel tubing. However, as will be discussed in more detail below, the components of the device may comprise any suitable materials formed by different methods without departing from the scope and spirit of this disclosure.

Referring to FIGS. 1-10, in a preferred embodiment of the present invention, the system 12 is adapted to be installed on a vehicle 14 and comprises a skid simulation system 8 and an overturn prevention system 26. The skid simulation system 8 generally comprises deployable auxiliary wheel assemblies 20 which, when lowered, reduce or eliminate the weight placed upon the conventional wheels and tires 18. Referring to FIG. 6, the auxiliary wheel assemblies 20 are positioned near the conventional wheels 18 and comprise a wheel 44 that is free spinning about a horizontal axis 21 and a swivel portion 38 that is free spinning about a vertical axis 16. The overturn prevention system 26 generally comprises a plurality of deployable lateral support members 10 which may be manually deployed from housing compartments 22 or automatically deployed upon receipt of a signal from sensors 24 such as accelerometer sensors 24 that the vehicle 14 is in danger of overturning.

a. Skid Simulation System.

Referring to FIGS. 1-5, & 8-10, the skid simulation system 8 comprises deployable auxiliary wheel assemblies 8 mounted to an undercarriage frame 28. The auxiliary wheel assemblies 20 are arranged such that they be raised and lowered by action of one or more hydraulic cylinders 34. When lowered, the auxiliary wheel assemblies 20 reduce or eliminate the weight placed upon the conventional wheels and tires 18. The auxiliary wheel assemblies 20 are positioned near the conventional wheels 18 and comprise a wheel 44 and swivel 38 arrangement. With this arrangement, the wheel 44 is free spinning about a horizontal axis 20 and the swivel 38 is free spinning about a vertical axle 16. As best shown in FIGS. 3 and 4, in the preferred embodiment, the undercarriage frame 28 comprises a generally rectangular configuration with one or more cross braces 29. Coupled to the frame 28, are one or more tubes 32 comprising hydraulic cylinders 34. The hydraulic cylinders 34 are coupled at a distal end to a vertical support member 36. The vertical support member 36 is coupled to a caster assembly 39. Each hydraulic cylinder 34 is in fluid communication with a hydraulic pump 40 (FIG. 7) which when activated, moves the hydraulic cylinder 34 vertically, thus raising and lowering the caster assemblies 39. Referring to FIG. 6, the caster assembly 39 comprises a mounting plate 42 beneath which one or more casters 41 are mounted. Casters 41 are rotationally coupled to the mounting plate 42 such that each caster 41 is capable of rotating 360°. Mounting plate 42 comprises a plurality of cooperative vertical coupling portions 46 spaced apart to accept cooperative vertical coupling portions 48 of vertical support member 36. Each of said coupling portions, 46, 48 comprises a rounded distal end 50. Vertical support member coupling portions 48 and mounting plate coupling portions 46 further comprise through openings 51 through which a pin 52 or other coupling mechanism 52 may be inserted so as to removably couple mounting plate to the vertical support member 36. Thus, the mounting plate 42 is pivotally coupled to vertical support member 36 such that the plate 42 and casters 44 may pivot upward and downward, as necessary.

a. Overturn Prevention System

Referring to FIG. 5 and FIGS. 8-9, the overturn prevention system 26 comprises a frame 47 mounted to the vehicle frame 30. In the preferred embodiment, the overturn prevention frame 47 comprises a generally triangular configuration. Thus, the legs of the triangle forming the overturn prevention frame 47 comprise two main tube assemblies 48 and a base formed by one or more cross braces 49.

Referring to FIGS. 8-9, telescopically arranged within each main tube assembly 48 is mid-portion 64. At a distal end 60, midportion 64 comprises a receiving element 56 to which a support hydraulic cylinder arm 58 may be coupled. The support hydraulic cylinder arm 58 is coupled to a support hydraulic cylinder 66 which is coupled to a proximal end of main tube assembly 48. Removably coupled and telescopically arranged within midportion 64 is extension portion 65. The extension portion 65 comprises an elongated tubular member coupled at a distal end to a lateral support caster assembly 68.

Each lateral support hydraulic cylinder 66 is in fluid communication with a hydraulic pump 40 which when activated, moves the lateral support hydraulic cylinder arm 58 inward and outward, thus, moving mid-portion 64 and extension portion 65, thus, raising and lowering the lateral support caster assembly 68. The lateral support caster assembly 68 comprises a lateral support mounting plate 70 beneath which one or more lateral support casters 72 are mounted. Lateral support casters 72 are rotationally coupled to the lateral support mounting plate 70 such that each lateral support caster 72 is capable of rotating 360°.

In FIG. 1, there is shown a conceptual figure of the overturn prevention system 26 in various embodiments. The lateral support members 10 of one such embodiment are positioned towards the rear of the vehicle 14. In this embodiment the lateral support members 10 comprise pads 13 at the ends which contact the driving surface and stabilize the vehicle 14 such that the vehicle 14 will not overturn. Also shown in FIG. 1, is a conceptual depiction of the lateral support members 10 positioned closer to the front of the vehicle 14 and with the ends comprising wheels. As may be seen, the lateral support system 26 can be positioned in various places on the vehicle 14 and can comprise various configurations. Additionally, although in the preferred embodiment, the system 12 comprises a single pair of lateral support members 10, the system 12 can comprise a different number of lateral support members 10. For example, the system 12 may comprise two pairs of lateral support members 10, as shown in conceptual FIG. 1, or may comprise additional lateral support members 10 depending upon the size of the vehicle 14 and the conditions under which it is operated.

Although, the system 12 currently is intended for fire trucks 14, the system 12 is well suited for other vehicles 14 such as ambulances, squad cars, and passenger vehicles.

Referring to FIG. 10, an isometric view of an alternative deployment mechanism 76 for use with the overturn prevention system 26 is provided. The alternative deployment mechanism 76 comprises a handle 74, and arm 80, a spring 82, and pivoting assembly 78. The main arm 47 can be moved manually by grasping handle 74 and moving main arm 47 outward. Such action will extend the mid-portion 64 from main tube assembly 48.

c. Operation

In operation, the system 12 uses pic technology with a state of the art touch screen computer controller. In the preferred embodiment, the system 12 comprises a touch screen HMI 6 (Human Machine Interface) connected to a PLC 4 (programmable logic controller) which controls a hydraulic and air system of the vehicle 14 as well as the overturn prevention system 26 (which may comprise pneumatically deployed/retracted lateral support members), retrieves data from sensors 24, and displays results of the student's performance on the HMI 6. The basic operation begins when the instructor sets up the simulator 12 by selecting a desired road condition or other anomaly to be presented to the student. The instructor may also choose from one of several preprogrammed scenarios from the computer. For example, system 12 may be configured to simulate an icy or wet road condition. By way of further example, but not by way of limitation, the system 12 may be configured to simulate a sandy or muddy condition or a one in which the surface of the road is pitted, damaged, or comprises an obstacle. In some scenarios, the system 12 may be configured to place an obstacle or distraction in the roadway or within the operator's field of vision. For example, an object may be programmed to be thrown in front of the vehicle 14. With the two computer systems, if the student makes an incorrect move threatening the safety of the vehicle 14 and its occupants, the instructor or computer can take over the scenario by deploying the overturn prevention system 26. The instructor can do this by simply pressing a button (or other selection member) and/or the computer can do this by, for example, sensing an excessive lateral G load or that the vehicle 14 has tipped beyond a predetermined level.

With the system 12 of the present invention, multiple combinations of vehicle 14 operation training scenarios are possible. Many variables and conditions may be presented to the operator of the emergency vehicle 14. With this system 12, the vehicle 14 operator learns what these variables are, how to account for and compensate for them, and, thus, safely operate the vehicle 14 in a variety of conditions and a number of scenarios.

The foregoing disclosure and showings made in the drawing are merely illustrative of the principles of this invention and are not to be interpreted in a limiting sense. While the invention is shown in only a few forms, it is not just limited to the forms shown, but is susceptible to various changes and modifications without departing from the spirit thereof. The foregoing description of a preferred embodiment of the invention has been presented for the purpose of illustration and description. It is not intended to be exhaustive or to limit the invention to the precise form disclosed. Obvious modifications or variations are possible in light of the above teachings. The invention may be adapted for use in a number of environments.

The embodiments were chosen and described to provide the best illustrations of the principles of the invention and its practical application, and to enable one of ordinary skill in the art to utilize the invention in various embodiments and with various modifications as are suited to the particular use contemplated. All such modifications and variations are within the scope of the invention in accordance with the breadth of this disclosure and appended claims, to which they are fairly, legally, and equitably entitled to be interpreted.

I claim:

1. A training vehicle comprising a plurality of lateral support members and one or more skid simulation members;
at least one of said lateral support members extending from a side of said training vehicle;
said lateral support members comprising distal portions, said distal portions being structured and arranged to come into contact with a driving surface when said vehicle tips beyond a pre-determined angle;
said skid simulation members comprising support assemblies; and
said support assemblies comprising a wheel portion and a swivel portion, said wheel portion being adapted for rotational movement about a horizontal axis, said swivel portion being adapted for rotational movement about a vertical axis.

2. The training vehicle of claim 1, at least one of said lateral support members comprising a telescopic arrangement.

3. The training vehicle of claim 2, at least one of said lateral support members comprising a main portion, a mid-portion, and an extension portion.

4. The training vehicle of claim 3, at least one of said distal portions comprising a caster assembly.

5. The training vehicle of claim 3, at least one of said distal portions comprising a skid pad.

6. The training vehicle of claim 5, said skid pad comprising an arcuate lower surface.

7. The training vehicle of claim 1, said lateral support members being adapted for positioning in first and second lateral support member positions, said lateral support members being retracted when in said first lateral support member position and extended when in said second lateral support member position.

8. The training vehicle of claim 7, said lateral support members being adapted for selective movement from said first lateral support member position to said second lateral support member position.

9. The training vehicle of claim 8, said vehicle being adapted for said selective movement while the vehicle is in motion.

10. The training vehicle of claim 1, said skid simulation members being adapted for positioning in first and second skid simulation member positions, said skid simulation members being retracted when in said first skid simulation member position and extended when in said second skid simulation member position.

11. The training vehicle of claim 10, said wheel portion being in contact with said driving surface when the skid simulation member is in the second skid simulation member position.

12. The training vehicle of claim 11, said skid simulation members being adapted for selective movement from said first skid simulation member position to said second skid simulation member position.

13. The training vehicle of claim 12, said vehicle being adapted for said selective movement while the vehicle is in motion.

14. The training vehicle of claim 1, said support assemblies comprising casters.

15. A training vehicle comprising a plurality of lateral support members and one or more skid simulation members;
at least one of said lateral support members extending from a side of said training vehicle;
said skid simulation members comprising support assemblies;
said lateral support members comprising distal portions;
said lateral support members being adapted for selective positioning in first and second lateral support member positions, said lateral support members being retracted when in said first lateral support member position and extended when in said second lateral support member position;
said lateral support members being adapted structured and arranged to automatically move from said first lateral support member position said second lateral support member position when said vehicle tips beyond a pre-determined angle;
said skid simulation members being adapted for selective positioning in first and second skid simulation member positions, said skid simulation members being retracted when in said first skid simulation member position and extended when in said second skid simulation member position; and
said support assemblies comprising a wheel portion and a swivel portion, said wheel portion being adapted for rotational movement about a horizontal axis, said swivel portion being adapted for rotational movement about a vertical axis.

16. The training vehicle of claim 15, said vehicle being adapted for said selective movements of said lateral support members and said skid simulation members while the vehicle is in motion.

17. The training vehicle of claim 15, the lateral support members comprising a telescopic arrangement.

18. The training vehicle of claim 15, said vehicle being a fire truck.
